(19) United States
(12) Patent Application Publication
(10) Pub. No.: US 2026/0138094 A1
(43) Pub. Date: May 21, 2026

(54) PROCESSES FOR PREPARING ASYMMETRIC HOLLOW FIBER MEMBRANES, ASYMMETRIC HOLLOW FIBER MEMBRANES AND USE OF ASYMMETRIC HOLLOW FIBER MEMBRANES

(71) Applicants: PETRÓLEO BRASILEIRO S.A. - PETROBRAS, Rio de Janeiro (BR); PAM MEMBRANAS SELETIVAS LTDA, Rio de Janeiro (BR)

(72) Inventors: Cristiano Piacsek BORGES, Rio de Janeiro (BR); Yuri Gomes LEITE E SILVA, Rio de Janeiro (BR); Nicolas Roger Jean-Daniel MERMIER, Rio de Janeiro (BR); Filippe MACHADO DE JESUS, Rio de Janeiro (BR); Ana Paula Santana MUSSE, Rio de Janeiro (BR); Leonardo Da Silva RIBEIRO, Rio de Janeiro (BR); Cassiano Gomes AIMOLI, Santos (BR); Dilson Da Costa Maia FILHO, Rio de Janeiro (BR)

(21) Appl. No.: 19/450,144

(22) Filed: Jan. 15, 2026

Related U.S. Application Data
(62) Division of application No. 18/518,804, filed on Nov. 24, 2023.

(30) Foreign Application Priority Data
Nov. 24, 2022 (BR) 1020220240027

(51) Int. Cl. B01D 67/00

(52) U.S. Cl. CPC B01D 67/0079; B01D 67/0088; B01D 67/0095; B01D 2323/081; B01D 2323/21; B01D 2323/2181; B01D 2323/219; B01D 2323/60

(57) ABSTRACT

The invention provides polymeric membranes with a mixed matrix and hollow fibers, with high mechanical resistance, useful in high pressure gas permeation processes such as, in particular, the removal of CO₂ from raw streams resulting from oil exploration. The membranes are formed by at least one polymeric layer consisting of at least one polymer and an inorganic filler of clay mineral nanoparticles. The respective co-extrusion processes applicable to the production of said membranes are also provided herein.

### CROSS-REFERENCE

This application is a divisional of U.S. application Ser. No. 18/518,804, filed Nov. 24, 2023, which claims priority to Brazilian Application No. 1020220240027, filed Nov. 24, 2022. Each of these applications is incorporated herein in its entirety by reference thereto.

### FIELD OF THE INVENTION

The invention is applicable to the production of asymmetric hollow fiber membranes, integral or composite, containing an inorganic filler. The resulting membranes have greater mechanical resistance and can be used in gas separation processes in high pressure environments, such as, for example, the separation of CO₂ from natural gas streams on Off-Shore production platforms.

### BACKGROUND OF THE INVENTION

Since the discovery of Loeb and Sourirajan, in the 1960s (LOEB. S., SOURIRAJAN S. Sea water demineralization by means of an osmotic membrane, Adv. Chem. Ser., volume 28, page 117, 1962), laboratories, research centers and companies have developed flat polymeric membranes with anisotropic/asymmetric capillary/hollow fiber types using the phase inversion technique. Since then, more advanced processes for synthesizing integral or composite polymeric membranes by co-extrusion (co-casting) (simultaneous double spreading) and/or by double precipitation/coagulation bath have been investigated both for capillary/hollow fibers and for flat membranes.

Each method has particular limitations, however the spinning process presents greater versatility in terms of the system and geometry of the extruders (spinnerets), thus, facilitating the continuous production of integral or composite commercial membranes by simple extrusion or simultaneous triple/quadruple co-extrusion.

Currently, the production of commercial membranes is widely requested to meet various applications requiring liquid-liquid, gas-liquid or gas-gas separation. The membranes are packaged in spiral-type modules in the case of flat membranes or hollow fiber-type modules in tubular casings/pressure vessels. The high degree of packaging of these modules provides a high separation area per equipment volume, suitable for use in limited physical spaces, easy installation and maintenance.

The in situ processing of extracted oil and raw gas resulting from Off-Shore exploration requires the integration of compact and safe equipment in locations with environments that require attention due to the high risk of accidents, in addition to minimizing environmental impacts. Membrane separation technology has the appropriate features to be implemented on an oil platform.

Cellulose acetate and/or tri-acetate membranes have been used for decades. This material presents a high degree of processability, as well as appropriate features with excellent transport properties to be used in gas permeation processes, seawater desalination, ultrafiltration of aqueous and non-aqueous solutions, diafiltration, ion exchange, salt concentration and juices, purification of polluted/contaminated streams and also in hemodialysis as artificial kidneys.

Flat membranes are already used in situ on Off-Shore oil exploration/production platforms. However, pressure losses due to fluid dynamics, problems arising from scaling and the insufficient potential of the degree of packaging of spiral-type modules can be limiting factors in the performance of the treatment of raw gas streams (CO₂ removal), whose increasing demand in volume to process requires ever more compact equipment with a larger separation area.

Asymmetric (or anisotropic) membranes of hollow fiber type integral with cellulose acetate (CA) or composed of a matrix of polyetherimide (PEI) or polyethersulfone (PES) on the support and cellulose acetate in the selective layer can be produced. The manufacturing process uses acetone (AO), methylpyrrolidone (NMP), formamide (FO) and dimethylformamide (DMF) as solvents, polyvinylpyrrolidone (PVP) and/or inorganic clay mineral fillers as additives.

The use of inorganic fillers or clay minerals (bentonites) in the polymeric matrix of the membrane can considerably increase its mechanical resistance and transport properties. The resulting mixed matrix membranes are therefore suitable for use in more severe pressure/temperature conditions, in particular for the removal of CO₂ in raw gas streams in situ on Off-Shore oil platforms.

For example, Jamil and collaborators (JAMIL, Asif et al. Development and performance evaluation of cellulose acetate-bentonite mixed matrix membranes for CO₂ separation. Advances in Polymer Technology, v. 2020, 2020 describe a method for producing asymmetric membranes including an inorganic filler in the cellulose acetate matrix through the dry-wet phase inversion technique.

However, despite presenting increased mechanical resistance compared to a membrane of similar composition, but without the inorganic filler, the membrane of Jamil and collaborators (2020) does not overcome limitations on the amount of clay mineral filler that can be added to the membrane, which, consequently, limits the gain in mechanical resistance provided by the inorganic filler.

### SUMMARY OF THE INVENTION

The invention provides asymmetric polymeric membranes of mixed matrix and hollow fibers, with greater mechanical resistance, useful for filtering CO₂ in high pressure gas streams. The membranes are formed by at least one polymeric layer and an inorganic filler of clay mineral nanoparticles. The respective production processes of said membranes are also provided here.

In one aspect of the invention, a process is provided for producing an integral asymmetric membrane, in the form of a hollow fiber, comprising a mixed matrix of cellulose acetate (CA) and clay mineral nanoparticles, which comprises:
a. simultaneous extrusion of a polymeric solution comprising cellulose acetate (CA), acetone (AO), formamide (FO) and a clay mineral-type filler, and of an inner liquid with precipitating features in relation to the polymeric solution;
b. immersion in an outer coagulation bath of filtered water between 25 and 80° C.;
c. continuous removal of the fiber formed by a mechanical device;
d. exposure of the formed fiber to a water bath at room temperature, for a period between 24 and 48 hours; and
e. drying the fibers by changing solvents followed by resting at room temperature.

In one embodiment of the process for producing an asymmetric integral membrane according to the invention, the clay mineral filler is composed of bentonite nanoparticles. And, in certain embodiments, the polymeric solution comprises from 23.5 to 26% m/m of cellulose acetate (CA), from 50 to 60% m/m of acetone (AO), from 12.5 to 26.4% m/m of formamide (FO) and 0.1 to 1.5% m/m of bentonite.

In certain instances of the invention, the distance between the extruder and the outer bath (DEB) is maintained between 0 and 100 cm.

In preferred embodiments, the process further comprises spraying a silicone-type elastomeric material onto the dry fibers.

Therefore, the invention also provides an asymmetric hollow fiber integral membrane formed by a mixed matrix of cellulose acetate and bentonite, with the mixed matrix comprising from 0.1 to 1.5% m/m of bentonite.

In a preferred embodiment, the asymmetric hollow fiber integral membrane is additionally coated with a layer of a silicone-type elastomer.

In another aspect of the invention, a process is provided for producing an asymmetric composite membrane, in the form of a hollow fiber, comprising an inner support layer, consisting of a mixed polymeric matrix containing clay mineral nanoparticles, and a selective outer layer, consisting of a cellulose acetate (CA) matrix with or without a clay mineral filler. This method comprises the steps of:
a. simultaneous extrusion of:
   i. a first polymeric solution, corresponding to the inner support layer, comprising a polymer selected from polyetherimide (PEI) or polyethersulfone (PES); one or more solvents selected from methylpyrrolidone (NMP), dimethylformamide (DMF), acetone (AO) and formamide (FO); polyvinylpyrrolidone (PVP), as a water-soluble additive; and a clay mineral type filler,
   ii. a second polymeric solution, corresponding to the selective outer layer, comprising cellulose acetate (CA), acetone (AO), formamide (FO) and, optionally, a clay mineral filler; and
   iii. an inner liquid with precipitating features in relation to the polymeric solution;
b. immersion in an outer coagulation bath of filtered water between 25 and 80° C.;
c. exposure of the formed fiber to a water bath at room temperature, for a period between 24 and 48 hours; and
d. drying the fibers by changing solvents followed by resting at room temperature.

In one embodiment of the process for producing an asymmetric composite membrane according to the invention, the clay mineral filler is composed of bentonite nanoparticles.

In certain embodiments, the first polymeric solution, corresponding to the inner support layer, comprises from 13.5 to 15% m/m of polyetherimide (PEI) as a base polymer, from 75 to 80% m/m of methylpyrrolidone (NMP), from 3.5 to 11.4% m/m of polyvinylpyrrolidone (PVP) and from 0.1 to 1.5% m/m of bentonite nanoparticles. In these embodiments, the inner liquid with precipitating features in relation to the polymeric solution comprises water and an aprotic solvent such as methylpyrrolidone (NMP) with ratios ranging between 70% H₂O:30% NMP (m/m) and 30% H₂O:70% MPN (m/m).

In certain embodiments, the first polymeric solution, corresponding to the inner support layer, comprises from 21 to 23% m/m of polyethersulfone (PES) as a base polymer, from 70 to 72% m/m of dimethylformamide (DMF), from 2 to 8% m/m of polyvinylpyrrolidone (PVP) and from 1 to 4% m/m of bentonite nanoparticles. In these embodiments, the inner liquid with precipitating features in relation to the polymeric solution comprises water and an aprotic solvent such as methylpyrrolidone (NMP) with ratios ranging between 70% H₂O:30% NMP (m/m) and 30% H₂O:70% NMP (m/m) and additionally dimethylformamide (DMF) in the range of 5 to 10% m/m.

In certain embodiments, the first polymeric solution, corresponding to the inner support layer, comprises from 23.5 to 26% m/m of cellulose acetate (CA), from 55 to 60% m/m of acetone (AO) of, from 12.5 to 21.4% m/m of formamide (FO) and from 0.1 to 1.5% m/m of bentonite nanoparticles. In these embodiments, the inner liquid with precipitating features in relation to the polymeric solution comprises pure distilled water and 5 to 10% m/m of a water-soluble polymer of the polyvinylpyrrolidone (PVP) type.

In certain embodiments, the second polymeric solution, corresponding to the selective outer layer, comprises from 24 to 27% m/m of cellulose acetate (CA), from 50 to 60% m/m of acetone (AO), from 13 to 26% m/m of formamide (FO) and 0.1 to 1.5% m/m of bentonite nanoparticles.

In process embodiments for preparing an asymmetric hollow fiber composite membrane, the distance between the extruder and the outer coagulation bath (DEB) is 0 to 100 cm.

In preferred embodiments, the process further comprises spraying a silicone-type elastomeric material onto the dry fibers.

Therefore, the invention also provides an asymmetric hollow fiber composite membrane with an inner support layer, consisting of a mixed matrix containing a polymer selected from polyetherimide (PEI), polyethersulfone (PES) or cellulose acetate (CA), and clay mineral nanoparticles; and a selective outer layer, consisting of a cellulose acetate (CA) matrix with or without clay mineral nanoparticles, in which the mixed matrix of the inner support layer comprises from 0.1 to 4.0% m/m of bentonite.

In a preferred embodiment, the asymmetric hollow fiber composite membrane is additionally coated with a layer of a silicone-type elastomer.

Furthermore, the invention also provides for the use of the asymmetric hollow fiber integral membrane or the asymmetric hollow fiber composite membrane described here for CO₂ removal in raw gas stream treatment processes.

### BRIEF DESCRIPTION OF THE FIGURES

To assist in identifying the main characteristics of this invention, the following figures are presented.

FIG. 1 represents the schematic of the equipment used for spinning, showing a single extruder (1a) and, alternatively, a triple extruder (1b); an inner liquid reservoir (3), an outer bath (4) and equipment for collecting fiber bundles with spinning speed control. The distance between the extruder and the bath (DEB) is also marked (6).

FIG. 2 shows a representation of the cross-section of the extruder, in which: (2A) represents the hole for passing the polymeric solution (CA, clay) for the production of integral hollow fibers; (2B) represents the hole for passing the polymeric solution (PEI, PES, AC, PVP, clay) to produce the support layer/matrix of composite hollow fibers; and (2C) refers to the hole for the inner liquid to pass through.

FIG. 3 shows representative photomicrographs of an asymmetric hollow fiber integral membrane according to the invention.

FIG. 4 shows representative photomicrographs of an asymmetric hollow fiber composite membrane according to the invention.

FIG. 5 illustrates the configuration of a system for testing the permeance, selectivity and mechanical resistance of the membranes of the invention.

FIG. 6 illustrates the superior performance of the membranes of the invention, compared to a commercially available membrane, in tests of permeance to CO₂, selectivity between CO₂ and CH₄ and mechanical resistance.

### DETAILED DESCRIPTION OF THE INVENTION

Unless otherwise specified, terms used throughout this specification have their common meanings in the art, within the context of the disclosure and in the specific context in which each term is used. Certain terms that are used to describe the disclosure are discussed below, or elsewhere in the specification, to provide additional guidance to the practitioner regarding the description of the disclosure. The publications cited herein and the material to which they are cited are specifically incorporated by reference in their entirety.

It will be appreciated that the same thing can be said in different ways. Accordingly, alternative language and synonyms may be used for any one or more of the terms discussed here. No special meaning should be placed on whether a term is elaborated or discussed here. Synonyms for certain terms are provided, but the exemplification of some synonyms does not exclude the potential use of others perhaps not listed here.

The terms “asymmetric membrane” and “anisotropic membrane” are synonymous and relate to the morphology of the membrane. The membranes of the invention are asymmetrical because they have a porous support structure and a thin surface layer, called skin, which may also have pores, but tends to be more closed than the support layer. When the “skin” and the support have the same material constitution, the membrane is said to be “integral”; when the material compositions are different, the membrane is said to be “composite”.

The terms “solvent” and “non-solvent” refer to the dissolution properties in relation to the membrane-forming polymer-the main component of the hollow fiber membrane as produced. In this way, polar aprotic liquids (for example DMA (dimethylacetamide), DMF (dimethylformamide), DMSO (dimethyl sulfoxide), NMP (N-methyl-2-pyrrolidone) can be considered “solvents” applicable in the context of the invention, since the membrane-forming polymer can be dissolved in these liquids or mixtures thereof. On the other hand, polar protic liquids such as water, ethanol or organic acids are “non-solvents”, since they do not dissolve the membrane-forming polymer.

The term “additive” is used in the context of the invention as any component capable of modifying the interaction between the components of the solution, influencing phase separation. In the case of hollow fibers, the additive aims to increase the viscosity of the solution, facilitating the extrusion step. Non-exhaustive examples include lithium chloride, PVP and organic or inorganic nanoparticles.

The expression “clay mineral filler”, in the context of the present invention, refers to a sedimentary material, formed by micrometric particles of one or more minerals derived from natural weathering. There are several types of clay minerals potentially applicable as inorganic fillers in the production of mixed matrix polymeric membranes. For example, montmorillonite, chloisite, kaolin and bentonite are clays employable in the context of the invention.

The term “nanoparticle”, in the context of the present invention, refers to any particle of matter with an average diameter equal to or greater than 1 nanometer and less than 100 nanometers.

The “inner liquid” is a fluid that presents precipitating features in relation to the polymeric solution and has in its composition water, solvent and/or a water-soluble polymer.

The invention provides spinning processes for the preparation of mixed matrix membranes with hollow fiber, useful for CO₂ separation in high pressure environments. Membranes can be prepared based on one or more polymers combined with an inorganic filler of mineral clay, responsible for providing greater mechanical resistance to the membranes described here.

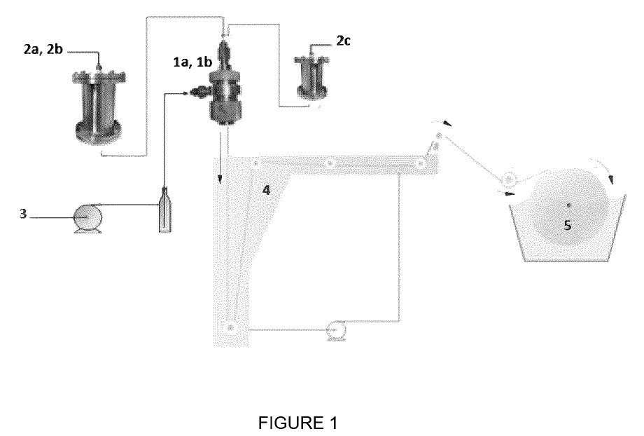

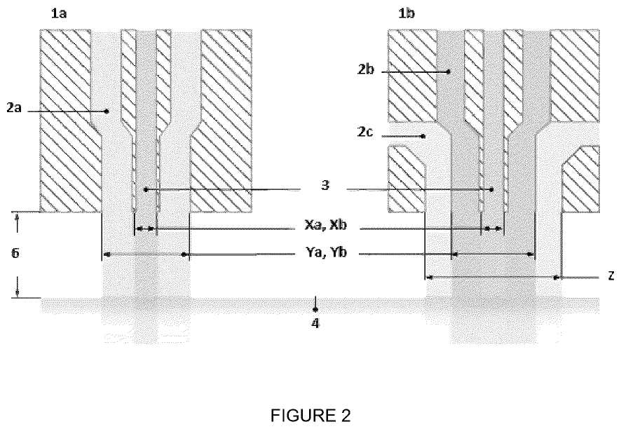

The spinning process basically consists of a simple extruder (1a) consisting of two inner channels, through which the polymeric solution (2a) flows, and an inner liquid (3) responsible for precipitation of the solution and maintaining the lumen inside the nascent fiber. Upon leaving the extruder, the solution is exposed to the environment for a time defined by the distance between the extruder and the outer precipitation bath (DEB; 6) (FIG. 1, FIG. 2). The degree of affinity between the phases and, therefore, the thermodynamic trajectories followed by the system, which depend on the chemical composition of the polymeric solution and the inner liquid, influence the final morphology of the resulting hollow fibers.

A particular feature of the spinning system for preparing hollow fibers is the double precipitation front, occurring on both the inner and outer surfaces of the membrane. Inner precipitation begins immediately at the exit of the extruder. On the other hand, the precipitation of the outer layer depends on the DEB (6) and the mass transfer between the nascent fiber and the inner liquid (3) that can reach the outer surface of the membrane before immersion in the outer precipitation bath (4).

Generally, the outer precipitation bath consists of microfiltered water only, due to its low cost and environmental reasons. The effect of environmental conditions (humidity, temperature) on the phase inversion mechanism initially occurring in the surface layers of the membrane depends on the exposure time of the nascent fiber and the volatility/hygroscopicity of the solvent(s) present in the polymer solution (2a, 2c). The degree of solvent evaporation and/or water absorption from the environment during this time interval is proportional to the DEB (6). This phenomenon directly impacts the initial precipitation conditions, influencing the morphological features and, consequently, the surface transport properties of the resulting fiber.

Another particular aspect of preparing hollow fibers is the viscoelastic expansion suffered by the nascent fiber when leaving the extruder and which can cause definitive deformation in its inner and/or outer perimeter. This deformation, called die-swell, is a function of the composition, flow rate and viscosity of the polymeric solution(s) and the inner liquid (3), as well as the distance (6) between the extruder and the outer precipitation bath (DEB).

In order to improve/increase the performance of membranes, additives such as inorganic salts and organic acids are used. The use of inorganic or organic nanoparticles in the concept of mixed matrix membranes controls their surface and mechanical features. These additives alter the interaction between the components of the solution, influencing the phase separation and, consequently, the morphology of the membrane obtained.

In the case of hollow fibers, the membranes are self-supporting, therefore they do not need a non-woven support/fabric to be produced, unlike flat membranes. In cases where the process requires high operating pressures, clay mineral nanoparticles (bentonites) can be added to the polymeric solution (2a, 2b, 2c) in order to increase its viscosity and, consequently, the mechanical resistance of the resulting fiber.

The simultaneous processing of two polymeric solutions (2b, 2c) by triple extrusion (1b) was developed to produce anisotropic composite membranes of the hollow fiber type. Depending on the process requirements and operating conditions (type of permeation, supply current), the selective layer can be freely placed inside or outside the fibers. In the same way as for simple extrusion (1a), the inner liquid flows through the central hole of the extruder, while the polymer solutions of the selective layer (skin) (2c) and support (2b) are located in the outer and inner annular spaces, respectively or vice versa (FIG. 2).

In the triple extrusion process, delamination between the support and skin layers is a critical factor that can directly affect the integrity of the composite hollow fibers. It occurs when the degree of shrinkage differs between the nascent layers, mainly at the beginning of the phase inversion process. The work of Matsuura et al. (Advanced Membrane Technology and Applications, John Wiley & Sons, Inc. 2008) showed that this phenomenon can be significantly reduced by controlling the viscosity of polymeric solutions, as well as adjusting the ratio between the flow rate of the outer layer solution in relation to the inner.

The invention allows the production of asymmetric hollow fiber membranes, from matrices formed by one (integral) or more polymers (composite) and mixed with nanoparticles of a mineral clay.

### Preparation of an Asymmetric Hollow Fiber Membrane Consisting of an Integral Mixed Polymer Matrix

The process for producing an asymmetric integral membrane in the form of a hollow fiber, consisting of a mixed matrix of cellulose acetate (CA) with clay mineral nanoparticles comprises the following.

Prepare a polymeric solution (2a) containing cellulose acetate (CA) as a base polymer with a concentration in the range of 23.5 to 26% m/m of acetone (AO), in the range of 55 to 60% m/m of formamide (FO), in the range of 12.5 to 21.4% m/m, as solvents, and bentonite, as clay mineral filler, added in the range of 0.1 to 1.5% m/m.

Simultaneous extrusion of the polymeric solution (2a) with an inner liquid (3) through simple extruder-type equipment (1a). The inner liquid (3) consists of water and has precipitating features in relation to the polymeric solution. The extruder, as seen in FIG. 2, consists of an annular space with an outer diameter (Ya) between 0.8 and 1.4 mm, concentrically to a central orifice with an inner diameter (Xa) between 0.1 and 0.3 mm (as shown in FIG. 2).

After extrusion, the polymeric solution and the inner liquid travel a distance (6) between the extruder and the outer coagulation bath (DEB) (4). During this interval, mass transfer occurs between the polymeric solution (2a) and the inner fluid/liquid (3), starting the process of liquid-liquid separation and vitrification of the concentrated phase in the base polymer.

The volume of solvent (AO) evaporated during the residence time between the extruder and the outer bath impacts the initial precipitation conditions, influencing the morphological features and, consequently, the surface transport properties of the resulting fiber. This volume is proportional to the DEB, which is maintained in the range of 0 to 100 cm.

Immersion in an outer coagulation bath (4) of filtered water, with a controlled temperature between 25 and 80° C. completes the vitrification process of the solid phase in the base polymer and fixes the final features of the fiber.

Then, the formed fiber is continuously removed by a mechanical device equipped (5) with speed control and which allows the fiber to be packaged in regular bundles, with a previously established amount of fiber. This device also allows tensioning of the nascent fiber, by adjusting the collection speed in the range of 100 to 120% of the extrusion speed (FIG. 1).

The formed fiber is kept in water baths at room temperature, for a period between 24 and 48 hours, to extract residual solvent and low molar mass additives. The fibers are dried by successively changing solvents, using alcohols to replace water, and non-polar and volatile hydrocarbons to replace alcohols. Evaporation of the final liquid contained in the pores is carried out at room temperature and completes drying.

After drying, the fiber goes through a process of coating with an elastomeric silicone-type material in order to correct any defects present on the surface of the membrane and, in this way, improve its transport properties, in particular selectivity. This process is carried out by a spraying technique. The distance between the nozzle and the membrane surface and the spraying time are defined experimentally to achieve a homogeneous/adequate coating.

### Preparation of an Asymmetric Hollow Fiber Membrane Made of a Mixed Composite Polymer Matrix

The process for producing an asymmetric composite membrane in the form of a hollow fiber, consisting of a mixed matrix of polyetherimide (PEI) with clay mineral-type nanoparticles in the support layer (inner) and a mixed/integral matrix of acetate cellulose (CA) with or without clay mineral nanoparticles in the surface selective layer, is analogous to the process for preparing the mixed integral polymer matrix membrane.

Initially, the process involves preparing two polymeric solutions corresponding, respectively, to the inner support layer and the outer selective layer. The solution that gives rise to the inner support layer (2b) is composed of a base polymer, a solvent, a water-soluble additive and bentonite, in the range between 0.1 and 4% m/m.

In certain embodiments, the base polymer of the inner support layer (2b) may be polyetherimide (PEI), polyethersulfone (PES) or cellulose acetate (CA). On occasions where the base polymer is PEI, this corresponds to 13.5 to 15% m/m of the polymeric solution. When the base polymer is PES, its concentration in the polymer solution is in the range between 21 and 23% m/m. When the base polymer is CA, its concentration in the polymer solution is in the range between 23.5 and 26% m/m.

In particular embodiments, the solvent can be methylpyrrolidone (NMP), dimethylformamide (DMF), acetone (AO) and/or formamide (FO). When NMP is the selected solvent, it is added to the polymer solution of the inner support layer in the range of 75 to 80% m/m. When DMF is the solvent chosen for the inner support layer, then it is added in a range between 70 and 72% m/m. In particular cases, AO and FO are used together in concentrations ranging, respectively, from 55 to 60% m/m and from 12.5 to 21.4% m/m.

Particularly, in the embodiments in which the base polymer of the inner support layer (2b) is CA, the solvents AO and FO are used together in the amounts reported above.

The water-soluble additive of the inner support layer (2b) is preferably polyvinylpyrrolidone (PVP). In certain embodiments, it is present in the range of 3.5 to 11.4% m/m and, in other particular embodiments, it is present in the range of between 2 and 8% m/m.

The solution that gives rise to the outer selective layer (2c) is composed of cellulose acetate (CA), as the base polymer, in the range between 24 and 26% m/m, acetone (AO) and formamide (FO), as solvents, in the ranges of 55 to 60% m/m and 14 to 21% m/m, respectively. Optionally, bentonite nanoparticles may be present in the range of 0.1 to 1.5% m/m.

Next, the polymeric solutions (2b, 2c) pass simultaneously through a triple extruder (1b), together with an inner liquid (3). The inner liquid (3) has precipitating features in relation to the polymeric solution and is made up of water and an aprotic solvent such as methylpyrrolidone (NMP), which has a physicochemical affinity with the polymeric solution, with proportions that vary between 70%/30% m/m and 30%/70% m/m, respectively.

Alternatively, the inner liquid with a H₂O/NMP composition of 30/70% m/m may also contain a water-soluble polymer of the polyvinylpyrrolidone (PVP) type. Another particular embodiment of the inner liquid comprises distilled water and polyvinylpyrrolidone (PVP) in the range of 5 to 10% m/m. The presence of the water-soluble polymer regulates the mass transfer rates between the polymeric solution (2b) and this liquid, as well as controlling the viscoelastic expansion effect at the extruder exit, allows uniformity in the thickness and inner perimeter of the fiber to be obtained.

Additionally, the inner liquid (3) may contain a solvent that has physicochemical affinity with the polymer solution, such as dimethylformamide (DMF). In these embodiments, DMF is present in the range between 5 to 10% m/m.

In its turn, the triple extruder (1b) consists of an annular space with an outer diameter (Z) between 1.2 and 1.4 mm, concentrically to a second inner annular space with an outer diameter (Yb) between 0.8 and 1 mm and a central hole with an inner diameter (Xb) between 0.1 and 0.2 mm (as shown in FIG. 2).

Analogous to the previous process, the polymeric solutions (2b, 2c) and the inner liquid (3) travel a distance (6) between the extruder and the outer coagulation bath (DEB) (4). During this interval, mass transfer occurs between the polymeric solution (2a) and the inner fluid/liquid (3), starting the process of liquid-liquid separation and vitrification of the concentrated phase in the base polymer.

Again, the volume of solvent (AO) evaporated during the residence time between the extruder and the outer bath impacts the initial precipitation conditions, influencing the morphological features and, consequently, the surface transport properties of the resulting fiber. This volume is proportional to the DEB, which is maintained in the range of 0 to 100 cm.

Immersion in an outer coagulation bath (4) of filtered water with a controlled temperature between 25 and 80° C. completes the vitrification process of the solid phase in the base polymers and fixes the final features of the fiber.

Then, the formed fiber is continuously removed by a mechanical device equipped (5) with speed control and which allows the fiber to be packaged in regular bundles, with a previously established amount of fiber. This device also allows tensioning of the nascent fiber, by adjusting the collection speed in the range of 100 to 120% of the extrusion speed (FIG. 1).

The formed fiber is kept in water baths at room temperature, for a period between 24 and 48 hours, to extract residual solvent and low molar mass additives. The fibers are dried by successively changing solvents, using alcohols to replace water, and non-polar and volatile hydrocarbons to replace alcohols. Evaporation of the final liquid contained in the pores is carried out at room temperature and completes drying.

After drying, the fiber goes through a coating process with an elastomeric silicone-type material in order to correct any defects present on the surface of the membrane and, in this way, improve its transport properties, in particular selectivity. This process is carried out by a spraying technique. The distance between the nozzle and the membrane surface and the spraying time are defined experimentally to achieve a homogeneous/adequate coating.

### Asymmetric Hollow Fiber Membranes

The invention provides for asymmetric polymeric membranes with a mixed matrix and hollow fibers, prepared using the processes described. In all embodiments, the membranes are formed by at least one polymeric layer and an inorganic filler of clay mineral nanoparticles. The presence of clay mineral in the polymeric matrix that constitutes at least one of the membrane layers increases the mechanical resistance of the membranes without reducing the selectivity for CO₂ filtration.

In one aspect, an asymmetric hollow fiber integral membrane formed by a mixed matrix of cellulose acetate and nanoparticles of the clay mineral bentonite is provided, with the mixed matrix comprising from 0.1 to 1.5% m/m of bentonite.

In another aspect, the invention provides an asymmetric hollow fiber composite membrane with an inner support layer, consisting of a mixed matrix containing a polymer selected from polyetherimide (PEI), polyethersulfone (PES) or cellulose acetate (CA), and clay mineral nanoparticles; and a selective outer layer, consisting of a cellulose acetate (CA) matrix with or without clay mineral nanoparticles, in which the mixed matrix of the inner support layer comprises from 0.1 to 4.0% m/m of bentonite.

In preferred embodiments of the asymmetric hollow fiber membrane, whether integral or composite, the membrane is additionally coated with a layer of a silicone-type elastomer.

### Application of Asymmetric Hollow Fiber Membranes

Finally, the invention provides for the use of the described membranes to remove CO₂ from raw gas streams in treatment processes, particularly those conducted in situ, that is, on an Off-Shore oil exploration/production platform.

Next, the invention will be illustrated through examples of embodiments, which do not exhaust all the possibilities achievable by the inventive concept described here, but represent all modalities. The examples below are presented in order to provide the person skilled in the art with a complete description of how the hollow fiber membranes of this invention are prepared, evaluated and used. One skilled in the art, in light of the present disclosure, will recognize that many changes can be made to the specific embodiments that are disclosed and still obtain a similar or equivalent result without departing from the spirit and scope of the invention.

### EXAMPLES

### Example 1—Production of Integral Hollow Fiber Membrane Without Clay Mineral Filler

An integral hollow fiber type membrane identified as AC_01 was produced. A polymeric solution (2a) was prepared with a concentration of cellulose acetate (CA) of 25% m/m as base polymer, acetone (AO) of 60% m/m and formamide (FO) of 15% m/m as solvents. No clay mineral nanoparticles were added.

The reagents were mixed together under mechanical stirring until the polymeric solution was homogeneous. The resulting polymeric solution (2a) is left to rest for 24 hours inside a stainless steel tank. It is then pumped towards the simple extruder (1a).

The wiring conditions are as follows:
A) Flow rate of the polymer solution: 6 [g/min]
b) Inner liquid flow: 1.5 [ml/min]
c) Retraction speed [m/min]: 8 m/min
d) Temperature of the outer coagulation bath (microfiltered water): 24° C.
e) Room temperature: 22° C.
f) DEB: 5 cm
There are no photomicrographs of this batch of membrane. Note that a thin layer of silicone-type elastomer was deposited on the outer surface of the membrane in order to correct any defects present.

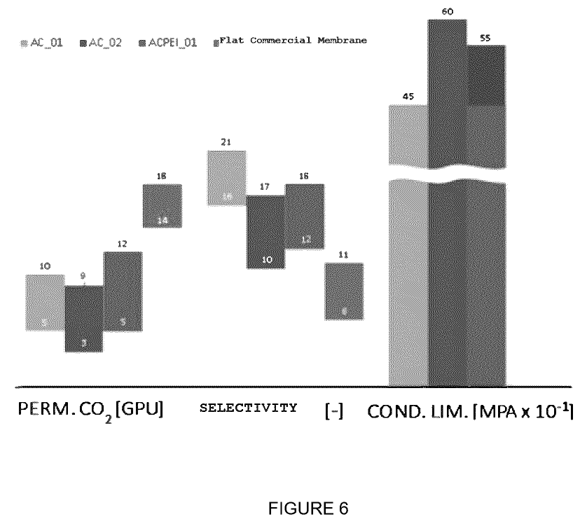

The permeation test was carried out with an ideal mixture of CH₄/CO₂ type with a composition of 70/30% m/m, using a module previously packed with the fibers produced in this example. The membranes show a permeance to CO₂ ranging between 5 and 10 [10⁻⁶ cm³(STP)cm⁻²s⁻¹cmHG⁻¹] or [GPU], up to 21 times greater than the permeance to CH₄. The fibers ruptured when the pressure reached 4.5 MPA (FIG. 6).

### Example 2—Production of Integral Hollow Fiber Membrane With Clay Mineral Filler

An integral hollow fiber type membrane identified as AC_02 was produced. A polymeric solution (2a) was prepared with a concentration of cellulose acetate (CA) of 24% m/m as base polymer, acetone (AO) of 60% m/m and formamide (FO) of 15% m/m as solvents. The concentration of the clay mineral filler of bentonite nanoparticles was 1% m/m.

Initially the nanoparticles are dispersed in formamide (FO). At this stage, ultrasound-type equipment was used in order to optimize the degree of clay swelling and obtain a homogeneous suspension. In parallel, the polymer (CA) is dissolved in the solvent (AO) under mechanical stirring until the solution is homogeneous. Then, the suspension (FO+Clay) is added to the solution (CA+AO).

The resulting polymer solution (2a) can then be pumped towards the simple extruder (1a). The resulting polymeric solution (2a) is left to rest for 24 hours inside a stainless steel tank. It is then pumped towards the simple extruder (1a).

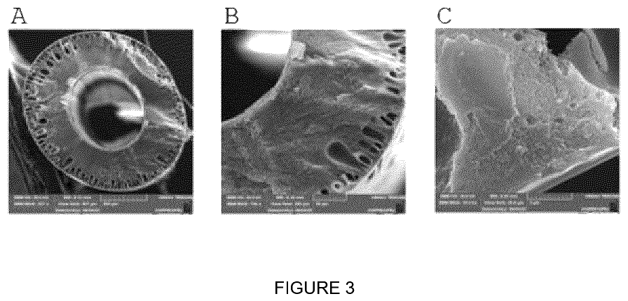

The wiring conditions are as follows:
g) Flow rate of the polymer solution: 6 [g/min]
h) Inner liquid flow: 1.5 [ml/min]
i) Retraction speed [m/min]: 8 m/min
j) Temperature of the outer coagulation bath (microfiltered water): 24° C.
k) Room temperature: 22° C.
l) DEB: 5 cm
The morphology of the hollow fibers obtained is shown in FIG. 3a,b, c. The fiber has an outer diameter of approximately 750 μm with a wall thickness of 250 μm. Note a dense morphology with finger-like macropores in the region close to the outer surface of the membrane. Note whether a thin 2 μm layer of silicone-type elastomer was deposited on the outer surface of the membrane (FIG. 3c).

The permeation test was carried out with a real mixture of CH₄/CO₂ type with a composition of 70/30% m/m, using a module previously packed with the fibers produced in this example. The membranes show a permeance to CO₂ ranging between 3 and 9 [10⁻⁶ cm³(STP)cm⁻²s⁻¹cmhg⁻¹] or [GPU], up to 17 times greater than the permeance to CH₄. The fibers ruptured when the pressure reached 6.0 MPA (FIG. 6).

### Example 3—Production of Hollow Fiber Composite Membrane With Clay Mineral Filler

A hollow fiber composite membrane identified as ACPEI_01 was produced. A polymeric solution (2b) was prepared with a concentration of polyetherimide (PEI) of 14% m/m as base polymer, methylpyrrolidone (NMP) of 75% as solvent, polyvinylpyrrolidone (PVP) of 10% m/m as a water-soluble additive. The concentration of the clay mineral filler (bentonite) was 1% m/m. Initially the nanoparticles are dispersed in methylpyrrolidone (NMP). At this stage, ultrasound-type equipment was used in order to optimize the degree of clay swelling and obtain a homogeneous suspension. Then, the polymer (PEI) and the additive (PVP) are dissolved in the suspension (NMP+Clay) under mechanical stirring until the solution is homogeneous.

A polymeric solution (2c) was prepared with a concentration of cellulose acetate (CA) of 26.7% m/m as base polymer, acetone (AO) of 50% m/m and formamide (FO) of 23.3% m/m as solvents.

The resulting polymeric solutions (2b and 2c) are left to rest for 24 hours inside stainless steel tanks. They will then be pumped towards the triple extruder (1b).

The wiring conditions are as follows:
a) Flow rate of the polymer solution (2b): 6 [g/min]
b) Flow rate of the polymer solution (2c): 1.5 [g/min]
c) Inner liquid flow: 2.4 [ml/min]
d) Retraction speed: 2 [m/min]
e) Temperature of the outer coagulation bath (microfiltered water): 24° C.

### f) Room Temperature: 22° C.

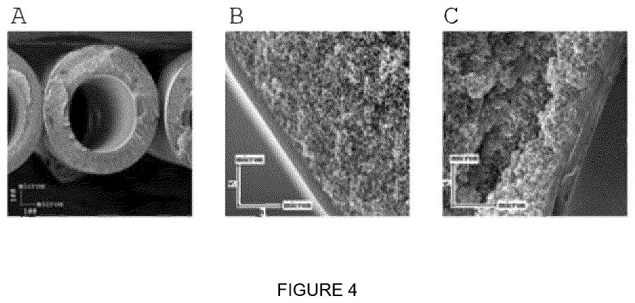

g) DEB: 2.4 cm
The morphology of the hollow fibers obtained is shown in FIG. 4a,b, c. The fibers have an outer diameter of approximately 875 μm with a wall thickness of 200 μm. An adequate adhesion can be observed between the selective dense layer of cellulose acetate located on the outer surface of the membrane and the polyetherimide (PEI) support layer presenting an anisotropic morphology with interconnected pores (FIG. 4c). Similarly for AC_01 and AC_02, a thin layer of silicone-type elastomer was deposited on the outer surface of the membrane.

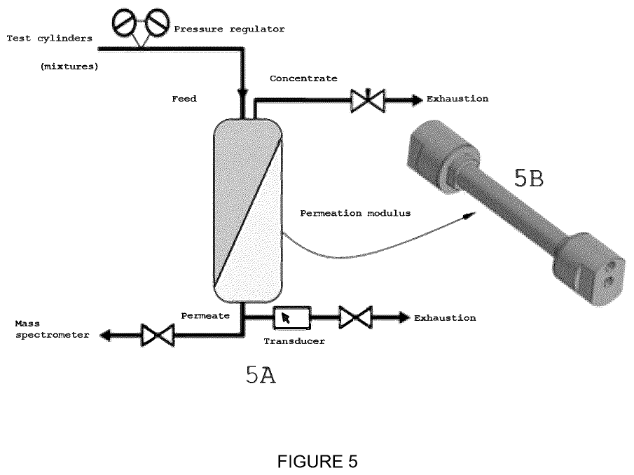

The permeation test was carried out with a real CH₄/CO₂ mixture with a composition of 70/30% m/m, using a hollow fiber module (FIG. 5b) previously packaged with the fibers produced in this example. The membranes show a permeance to CO₂ ranging between 5 and 12 [10⁻⁶ cm³(STP) cm⁻²s⁻¹cmhg⁻¹] or [GPU], up to 18 times greater than the permeance to CH₄. The fibers ruptured when the pressure reached 5.5 MPA (FIG. 6).

The addition of nanoparticles had no relevant impact on the transport properties of the fibers produced, while the mechanical resistance was consequently increased (between 20 and 25%).

The composite membrane has higher permeance values compared to integral membranes as it is a selective layer of thin cellulose acetate (CA) offering less resistance to transport.

A test was carried out with a flat commercial membrane under the same conditions as in examples 1, 2 and 3. It should be noted that the hollow fiber type membranes produced present a much higher CO₂/CH₄ selectivity compared to the commercial membrane, while the permeance to CO₂ presents proportionally lower values.

1. A process for producing an asymmetric composite membrane in the form of a hollow fiber, the asymmetric composite membrane comprising an inner support layer, the asymmetric composite membrane consisting of a mixed polymeric matrix containing clay mineral nanoparticles, and a selective outer layer, the asymmetric composite membrane consisting of a cellulose acetate matrix (CA) with or without a clay mineral filler, the process comprising:
simultaneous extrusion of:
a first polymeric solution, corresponding to the inner support layer, the first polymeric solution comprising:
a polymer selected from polyetherimide (PEI) or polyethersulfone (PES);
one or more solvents selected from methylpyrrolidone (NMP), dimethylformamide (DMF), acetone (AO) and formamide (FO);
a water-soluble additive comprising polyvinylpyrrolidone (PVP); and
a clay mineral-type filler;
a second polymeric solution, corresponding to the selective outer layer, the second polymeric solution comprising cellulose acetate (CA), acetone (AO), and formamide (FO) and, optionally, a clay mineral filler; and
an inner liquid with precipitating features in relation to the polymeric solution;
immersion in an outer coagulation bath of filtered water between 25° C. and 80° C.;
exposure of the formed fiber to a water bath at room temperature for a period between 24 hours and 48 hours; and
drying the fibers by changing solvents followed by resting at room temperature.

2. The process of claim 1, further comprising a clay mineral filler, wherein the clay mineral filler is composed of bentonite nanoparticles.

3. The process of claim 1, wherein the first polymeric solution corresponding to the inner support layer comprises from 13.5% to 15% m/m of polyetherimide (PEI) as base polymer, from 75% to 80% m/m of methylpyrrolidone (NMP), from 3.5% to 11.4% m/m of polyvinylpyrrolidone (PVP) and from 0.1% to 1.5% m/m of bentonite nanoparticles.

4. The process of claim 3, wherein the inner liquid with precipitating features in relation to the polymeric solution comprises:
water; and
an aprotic solvent of the methylpyrrolidone type (NMP),
wherein the water and the aprotic solvent are in a ratio of between 70% H₂O:30% NMP (m/m) and 30% H₂O:70% NMP (m/m).

5. The process of claim 1, wherein the first polymeric solution, corresponding to the inner support layer, comprises from 21% to 23% m/m of polyethersulfone (PES) as base polymer, of 70% to 72% m/m of dimethylformamide (DMF), 2% to 8% m/m of polyvinylpyrrolidone (PVP) and 1% to 4% m/m of bentonite nanoparticles.

6. The process of claim 5, wherein the inner liquid with precipitating features in relation to the polymeric solution comprises:
water; and
an aprotic solvent of the methylpyrrolidone type (NMP), wherein the water and the aprotic solvent are in a ratio of between 70% H₂O:30% NMP (m/m) and 30% H₂O:70% NMP (m/m); and
dimethylformamide (DMF) in the range of 5 to 10% m/m.

7. The process of claim 1, wherein the first polymeric solution, corresponding to the inner support layer, comprises from 23.5% to 26% m/m of cellulose acetate (CA), from 55% to 60% m/m of acetone (AO), from 12.5% to 21.4% m/m of formamide (FO), and from 0.1 to 1.5% m/m of bentonite nanoparticles.

8. The process of claim 7, wherein the inner liquid with precipitating features in relation to the polymeric solution comprises:
pure distilled water; and
5% to 10% m/m of a water-soluble polymer of the polyvinylpyrrolidone (PVP) type.

9. The process of claim 1, wherein the second polymeric solution, corresponding to the selective outer layer, comprises from 24% to 27% m/m of cellulose acetate (CA), from 50% at 60% m/m of acetone (AO), from 13% to 26% m/m of formamide (FO), and from 0.1% to 1.5% m/m of bentonite nanoparticles.

10. The process of claim 1, wherein the distance between the extruder and the outer coagulation bath is 0 cm to 100 cm.

11. The process of claim 1, further comprising spraying a silicone-type elastomeric material onto the dry fibers.
